(19) United States
(12) Patent Application Publication
(10) Pub. No.: US 2010/0304608 A1
(43) Pub. Date: Dec. 2, 2010

(54) Angled Coaxial Junction

(76) Inventor: Jan Michael Clausen, Vordingborg (DK)

Correspondence Address: CORNING INCORPORATED, SP-TI-3-1, CORNING, NY, 14831, US

(21) Appl. No.: 12/471,908

(22) Filed: May 26, 2009

(51) Int. Cl. H01R 9/05; H01B 13/20

(52) U.S. Cl. 439/582; 29/828

(57) ABSTRACT

A coaxial connector includes a tubular body, an angled inner conductor disposed within the tubular body, and a first inner terminal and a second inner terminal. The first inner terminal is releasably attached to a first end of the angled inner conductor and the second inner terminal is releasably attached to a second end of the angled inner conductor.

### BACKGROUND OF THE INVENTION

1. Field of the Invention

The present invention relates generally to a connector for coaxial cables, and particularly to an angled coaxial connector for coaxial cable interface configurations.

2. Technical Background

Many of the current right angle product offerings are designed specifically to adapt one type of connector end to another type of connector end designed exclusively for that purpose. Such design approaches often require customized components that are time consuming and costly to fabricate and assemble. In addition, such approaches typically require tedious electrical tuning during the developmental stage, causing delays in development and time to market.

Two such examples are U.S. Pat. No. 2,813,144 which discloses a connector with a central conductor with reduced inner end portion which is bent at right angles and brazed or soldered into the end bore of a conductor, and EP 0 090 538, which describes an angle connector wherein a ferrule section is crimped onto a central conductor. Both these methods involve connecting the two perpendicular connectors and can have potential disadvantages. First, both require a rigid perpendicular connection and this requires access to the perpendicular connection so that the crimping, brazing or soldering can take place. Providing such access to the perpendicular connection increases the complexity of the parts manufactured as well as adding complications to the whole assembly process. Second, any displacement of either the plug-end or jack-end interfaces may result in the perpendicular connection bending or breaking resulting in a loss or a deterioration of contact.

### SUMMARY OF THE INVENTION

One aspect of the invention is a coaxial connector. The coaxial connector includes a tubular body having an inner surface, an outer surface, a first end and a second end. The tubular body is disposed about a first and second axis, wherein the second axis is at an angle relative to the first axis. The coaxial connector also includes an angled inner conductor disposed within the tubular body. The angled inner conductor includes a first end and a second end, wherein the first end is generally coaxial with the first axis and the second end is generally coaxial with the second axis. In addition, the coaxial connector includes a first inner terminal and a second inner terminal, wherein the first inner terminal is releasably attached to the first end of the angled inner conductor and the second inner terminal is releasably attached to the second end of the angled inner conductor.

In another aspect, the present invention includes a method of making a coaxial connector. The method includes inserting an angled inner conductor into a tubular body. The tubular body has an inner surface, an outer surface, a first end and a second end. The tubular body is disposed about a first axis and a second axis, wherein the second axis is at an angle relative to the first axis. The angled inner conductor includes a first end and a second end, wherein the first end is generally coaxial with the first axis and the second end is generally coaxial with the second axis. In addition, the method includes releasably attaching a first inner terminal to a first end of the angled inner conductor and releasably attaching a second inner terminal to a second end of the angled inner conductor.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 illustrates a partial cross-sectional view of one embodiment of the present invention;

FIG. 2 illustrates a partial cross-sectional view of an alternate embodiment of the present invention;

FIG. 3 illustrates a partial cross-sectional view of components of the connector illustrated in FIG. 2; and

FIG. 4 illustrates a partial cross-sectional view of components of the connector illustrated in FIG. 1.

### DETAILED DESCRIPTION OF THE PREFERRED EMBODIMENTS

Reference will now be made in detail to the present preferred embodiments of the invention, examples of which are illustrated in the accompanying drawings. Whenever possible, the same reference numerals will be used throughout the drawings to refer to the same or like parts.

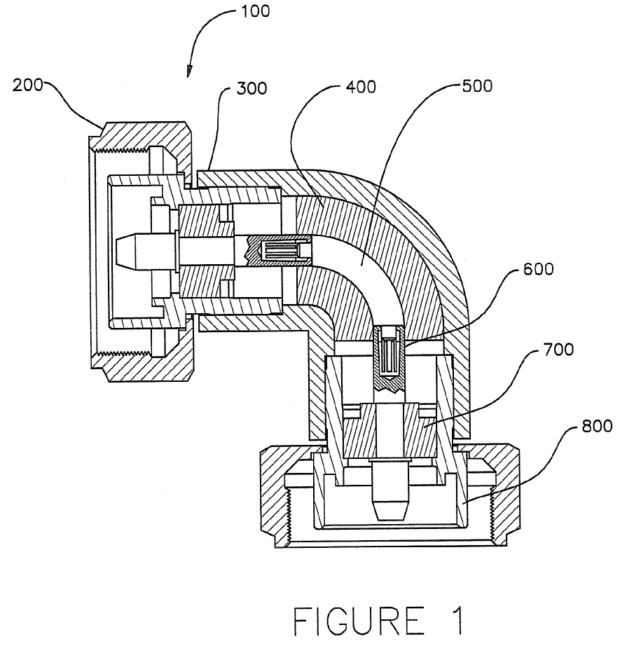

FIG. 1 illustrates an embodiment of a connector as disclosed herein. Connector 100 includes a tubular body 300 having an inner surface, an outer surface, a first end and a second end. Tubular body 300 is preferably made from a metal plated metal alloy, such as a nickel plated zinc alloy. As shown in FIG. 1, tubular body 300 is disposed about a first and a second axis, wherein the second axis is at an angle relative to the first axis. Preferably, the second axis is at an angle of about 90° relative to the first axis.

Connector 100 also includes an angled inner conductor 500 that is disposed within tubular body 300. Angled inner conductor 500 is preferably made from a metal plated metal alloy, such as tin or gold plated brass. Angled inner conductor 500 has a first end and a second end, wherein the first end is generally coaxial with the first axis and the second end is generally coaxial with the second axis. In addition, connector includes inner terminals 600, including first inner terminal and second inner terminal, each of the first and second inner terminals having an inner and outer end, wherein the inner end of the first inner terminal is releasably attached to the first end of angled inner conductor 500 and the inner end of the second inner terminal is releasably attached to the second end of angled inner conductor 500. Inner terminals 600 are preferably made from a metal plated metal alloy, such as tin or gold plated beryllium copper.

In the embodiment shown in FIG. 1, the first end and the second end of angled inner conductor 500 each have a male contact interface and the inner end of the first inner terminal and inner end of the second inner terminal each have a female contact interface. Preferably, each female contact interface includes a plurality of radially extending fingers, the ends of which surround and releasably attach the male contact interfaces at the first and second end of angled inner conductor 500.

Inner terminals 600 are each housed in interface bodies 800, which include a first interface body and a second interface body, the first inner terminal being housed in the first interface body and the second inner terminal being housed in the second interface body. Interface bodies 800 are preferably made from a metal plated metal alloy, such as nickel or tin plated brass. First and second interface bodies are preferably press fit into the first and second ends of tubular body 300.

Connector 100 also includes an insulating member 400, wherein the insulating member is housed within and contacts the inner surface of tubular body 300 and preferably surrounds and contacts angled inner conductor 500. Insulating member 400 is preferably made from an insulative plastic, such as Acetal or TPX.

Connector 100 additionally includes tubular insulators 700, including a first tubular insulator and a second tubular insulator, wherein the first tubular insulator is housed in and contacts the first interface body and the second tubular insulator is housed in and contacts the second interface body. First tubular insulator surrounds and contacts at least a portion of first inner terminal and second tubular insulator surrounds and contacts at least a portion of second inner terminal. Tubular insulators 700 are preferably made from an insulative plastic material, such as PTFE.

Connector 100 further includes coupling nuts 200, including a first coupling nut and a second coupling nut. The first coupling nut is rotatably attached to the first interface body and the second coupling nut is rotatably attached to the second interface body. Coupling nuts 200 are preferably made from a metal plated metal alloy, such as nickel plated brass.

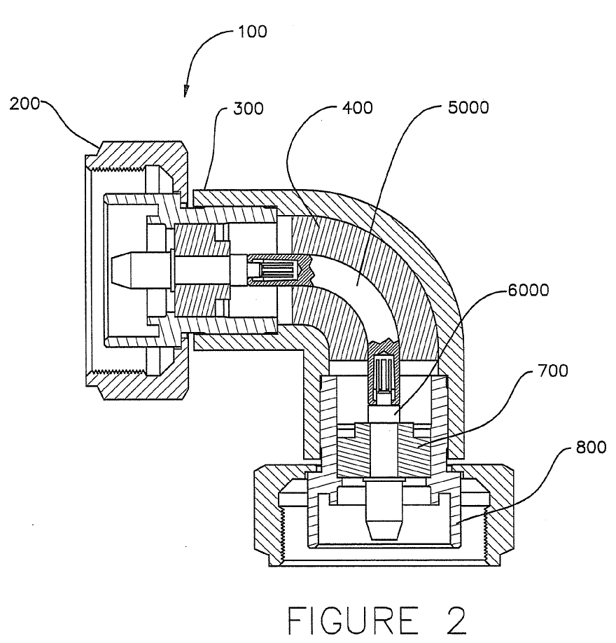

FIG. 2 illustrates an alternate embodiment of a connector as disclosed herein. The connector 100 illustrated in FIG. 2 is the same as the connector illustrated in FIG. 1 with respect to tubular body 300, interface bodies 800, insulating member 400, tubular insulators 700, and coupling nuts 200. The connector 100 illustrated in FIG. 2 differs from the connector illustrated in FIG. 1 in that, instead of including angled inner conductor 500 and inner terminals 600, the connector illustrated in FIG. 2 includes angled inner conductor 5000 and inner terminals 6000.

Angled inner conductor 5000 is disposed within tubular body 300 and is preferably made from a metal plated metal alloy, such as tin or gold plated beryllium copper. Angled inner conductor 5000 has a first end and a second end, wherein the first end is generally coaxial with a first axis and the second end is generally coaxial with a second axis.

Inner terminals 6000, include a first inner terminal and a second inner terminal, each of the first and second inner terminals having an inner and outer end, wherein the inner end of the first inner terminal is releasably attached to the first end of angled inner conductor 5000 and the inner end of the second inner terminal is releasably attached to the second end of angled inner conductor 5000. Inner terminals 6000 are preferably made from a metal plated metal alloy, such as tin or gold plated brass.

In the embodiment shown in FIG. 2, the first end and the second end of angled inner conductor 5000 each have a female contact interface and the inner end of the first inner terminal and inner end of the second inner terminal each have a male contact interface. Preferably, each female contact interface includes a plurality of radially extending fingers, the ends of which surround and releasably attach the male contact interfaces at inner ends of the first and second inner terminals 6000.

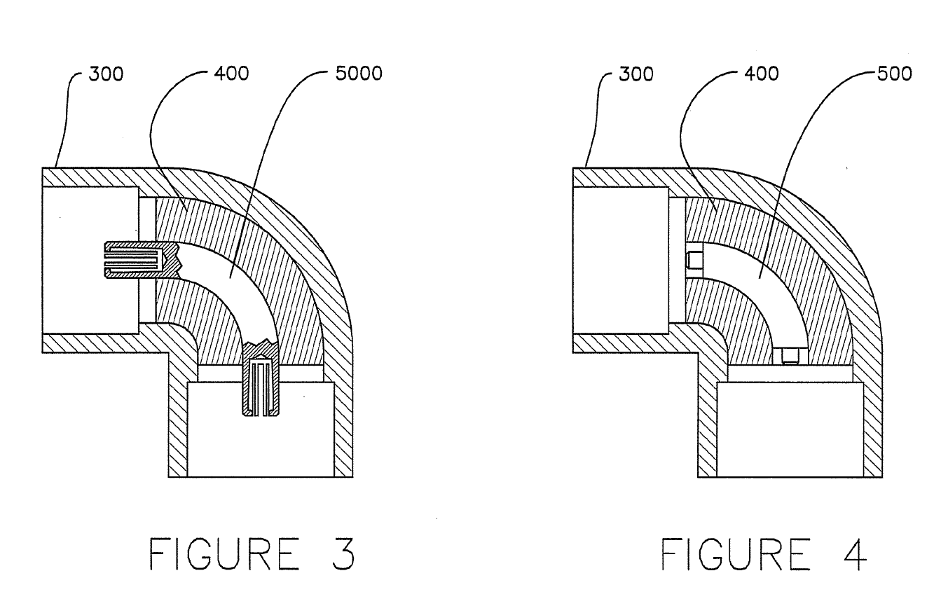

The connectors illustrated in FIGS. 1 and 2 can be assembled by first inserting angled inner conductor 500 or 5000 into tubular body 300. Next, angled inner conductor 500 or 5000 is surrounded with insulating member 400, wherein insulating member 400 also is housed within and contacts the inner surface of tubular body 300. Insulating member 400 can be preformed to fit around angled inner conductor 500 or 5000 or it can be injected into the annular region between angled inner conductor 500 or 5000 and tubular body. FIG. 4 illustrates the connector illustrated in FIG. 1 (having angled inner conductor 500) at this partial stage of assembly and FIG. 3 illustrates the connector illustrated in FIG. 2 (having angled inner conductor 5000) at this partial stage of assembly.

The connectors illustrated in FIGS. 1 and 2 are then assembled by surrounding the first and second inner terminals 600 or 6000 with first and second tubular insulators 700 to create inner terminal-insulator subassemblies. Preferably, tubular insulators 700 are snap fit around first and second inner terminals 600 or 6000.

Inner terminal-insulator subassemblies are then releasably attached to angled inner conductor 500 or 5000. In the embodiment illustrated in FIG. 1, inner end of first inner terminal is releasably attached to the first end of angled inner conductor 500 and the inner end of the second inner terminal is releasably attached to the second end of angled inner conductor 500. Specifically, each female contact interface at the inner end of first and second inner terminals 600 includes a plurality of radially extending fingers, the ends of which surround and releasably attach the male contact interfaces at the first and second ends of angled inner conductor 500.

In the embodiment illustrated in FIG. 2, inner end of first inner terminal is releasably attached to the first end of angled inner conductor 5000 and the inner end of the second inner terminal is releasably attached to the second end of angled inner conductor 5000. Specifically, each female contact interface at the first and second end of angled inner conductor 5000 includes a plurality of radially extending fingers, the ends of which surround and releasably attach the male contact interfaces at the inner end of first and second inner terminals 6000.

Next, first and second coupling nuts 200 are rotatably attached to first and second interface bodies 800. Following attachment of coupling nuts 200 to interface bodies 800, first interface body is press fit into a first end of tubular body 300 and second interface body is press fit into a second end of tubular body 300.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A coaxial connector comprising:
a tubular body having an inner surface, an outer surface, a first end and a second end, said tubular body disposed about a first and second axis, wherein the second axis is at an angle relative to the first axis;
an angled inner conductor disposed within the tubular body, the angled inner conductor having a first end and a second end, wherein the first end is generally coaxial with the first axis and the second end is generally coaxial with the second axis; and
a first inner terminal and a second inner terminal, wherein said first inner terminal is releasably attached to said first end of said angled inner conductor and said second inner terminal is releasably attached to said second end of said angled inner conductor.

2. The coaxial connector of claim 1, wherein the angle is about 90°.

3. The coaxial connector of claim 1, wherein the first end and the second end of the angled inner conductor each comprise a female contact interface.

4. The coaxial connector of claim 3, wherein the first inner terminal and the second inner terminal each comprise a male contact interface, wherein the male contact interface of the first inner terminal is releasably attached to the female contact interface of the first end of the angled inner conductor and the male contact interface of the second inner terminal is releasably attached to the female contact interface of the second end of the angled inner conductor.

5. The coaxial connector of claim 1, wherein the first end and the second end of the angled inner conductor each comprise a male contact interface.

6. The coaxial connector of claim 5, wherein the first inner terminal and the second inner terminal each comprise a female contact interface, wherein the female contact interface of the first inner terminal is releasably attached to the male contact interface of the first end of the angled inner conductor and the female contact interface of the second inner terminal is releasably attached to the male contact interface of the second end of the angled inner conductor.

7. The coaxial connector of claim 1, wherein the first inner terminal is housed in a first interface body and the second inner terminal is housed in a second interface body, wherein first interface body is press fit into the first end of tubular body and the second interface body is press fit into the second end of the tubular body.

8. The coaxial connector of claim 1, wherein the connector further comprises an insulating member, wherein the insulating member is housed within and contacts the inner surface of the tubular body and surrounds and contacts the angled inner conductor.

9. The coaxial connector of claim 7, wherein the connector further comprises a first tubular insulator and a second tubular insulator, wherein the first tubular insulator is housed in and contacts the first interface body and the second tubular insulator is housed in and contacts the second interface body, and wherein the first tubular insulator surrounds and contacts at least a portion of the first inner terminal and the second tubular insulator surrounds and contacts at least a portion of the second inner terminal.

10. The coaxial connector of claim 7, wherein the connector further comprises a first coupling nut and a second coupling nut wherein the first coupling nut is rotatably attached to the first interface body and the second coupling nut is rotatably attached to the second interface body.

11. A method of making a coaxial connector, the method comprising:
inserting an angled inner conductor in a tubular body, the tubular body having an inner surface, an outer surface, a first end and a second end, said tubular body disposed about a first and second axis, wherein the second axis is at an angle relative to the first axis and
the angled inner conductor having a first end and a second end, wherein the first end is generally coaxial with the first axis and the second end is generally coaxial with the second axis;
releasably attaching a first inner terminal to said first end of said angled inner conductor; and
releasably attaching a second inner terminal to said second end of said angled inner conductor.

12. The method of claim 11, wherein the angle is about 90°.

13. The method of claim 11, wherein the first end and the second end of the angled inner conductor each comprise a female contact interface.

14. The method of claim 13, wherein the first inner terminal and the second inner terminal each comprise a male contact interface, wherein the male contact interface of the first inner terminal is releasably attached to the female contact interface of the first end of the angled inner conductor and the male contact interface of the second inner terminal is releasably attached to the female contact interface of the second end of the angled inner conductor.

15. The method of claim 11, wherein the first end and the second end of the angled inner conductor each comprise a male contact interface.

16. The method of claim 15, wherein the first inner terminal and the second inner terminal each comprise a female contact interface, wherein the female contact interface of the first inner terminal is releasably attached to the male contact interface of the first end of the angled inner conductor and the female contact interface of the second inner terminal is releasably attached to the male contact interface of the second end of the angled inner conductor.

17. The method of claim 11, wherein the first inner terminal is housed in a first interface body and the second inner terminal is housed in a second interface body, wherein first interface body is press fit into the first end of tubular body and the second interface body is press fit into the second end of the tubular body.

18. The method of claim 11, wherein the method further comprises surrounding the angled inner conductor with an insulating member, wherein the insulating member is housed within and contacts the inner surface of the tubular body.

19. The method of claim 11, wherein the method further comprises surrounding the first inner terminal with a first tubular insulator and surrounding the second inner terminal with a second tubular insulator.

20. The method of claim 17, wherein the method further comprises rotatably attaching a first coupling nut to the first interface body and rotatably attaching a second coupling nut to the second interface body.
